(19) United States
(12) Patent Application Publication
(10) Pub. No.: US 2026/0237243 A1
(43) Pub. Date: Aug. 13, 2026

(54) METHOD, APPARATUS, AND SYSTEM FOR IDENTIFYING TASK FROM VIDEO FRAMES

(71) Applicant: NEC Corporation, Tokyo (JP)

(72) Inventors: Masafumi WATANABE, Tokyo (JP); Hayato CHISHAKI, Tokyo (JP)

(73) Assignee: NEC Corporation, Tokyo (JP)

(21) Appl. No.: 19/475,085

(22) PCT Filed: Apr. 11, 2024
(86) PCT No.: PCT/JP2024/014603

§ 371 Date: Oct. 14, 2025

(30) Foreign Application Priority Data
Apr. 28, 2023 (SG) 10202301201Q

(51) Int. Cl. G06V 40/20; G06T 7/246; G06V 20/40

(52) U.S. Cl. CPC G06V 40/28; G06T 7/246; G06V 20/41; G06T 2207/10016; G06T 2207/30196

(57) ABSTRACT

A method includes: determining whether each of a first and a second sequences of movement points comprises a first movement point at a first ordinal number and a second movement point at a second ordinal number within the each of the first and the second sequences of movement points, wherein the first and second sequences of movement points comprise a first plurality and a second plurality of movement points of one or more body parts of the person ordered according to respective time points at which the first plurality and the second plurality of movement points are detected from a first series and a second series of video frames, respectively; and identifying a start and an end of a sequence of movement points to perform the task by the person from the first sequence and/or the second sequence of movement points based on the first and the second movement point.

### TECHNICAL FIELD

The present disclosure relates to task identification method, apparatus, and more particularly, relates to a method, an apparatus, and a system for identifying a task performed by a person from a series of video frames.

### BACKGROUND ART

Currently, many jobs at assembly lines in factories are still performed by humans however defects are often attributed to human causes. Manufacturers are very concerned about controlling the quality of the production of the assembly lines and there have been strong needs to assure that every task at the assembly lines is performed correctly; otherwise defective products may be shipped and resulted in recall.

Solutions that check if tasks performed by a person are correctly done or not have emerged by using machine learning based method. These include a solution that uses human pose estimator and a solution that uses finger pose estimator and object detector. However, to use a deep learning model to check if assembly tasks are correctly done or not, the user is required to train the model with known “correct answers”, such as start and end timing of the task in a sample video, in order to annotate and identify the task. Such annotation work, especially when the number of tasks at one station may exceed 100 if it is in cell production system, may take ridiculously long time which prevents users from introducing such solution.

### SUMMARY OF INVENTION

### Technical Problem

There is thus a need that provide a method, an apparatus and a system for identifying a task performed by a person from a series of video frames to address the above challenges. Furthermore, other desirable features and characteristics will become apparent from the subsequent detailed description and the appended claims, taken in conjunction with the accompanying drawings and this background of the disclosure.

### Solution to Problem

In a first aspect, the present disclosure provides a method for identifying a task performed by a person from a series of video frames, the method comprising: determining, by a processor, whether each of a first sequence of movement points and a second sequence of movement points comprises a first movement point at a first ordinal number and a second movement point at a second ordinal number within the each of the first sequence of movement points and the second sequence of movement points, wherein the first sequence of movement points and the second sequence of movement points comprise a first plurality of movement points and a second plurality of movement points of one or more body parts of the person ordered according to respective time points at which the first plurality of movement points and the second plurality of movement points are detected from a first series of video frames and a second series of video frames corresponding to a detection area, respectively; and in response to a result of the determination, identifying, by the processor, a start and an end of a sequence of movement points to perform the task by the person from the first sequence of movement points and/or the second sequence of movement points based on the first movement point and the second movement point.

In a second aspect, the present disclosure provides an apparatus for identifying a task performed by a person from a series of video frames, the apparatus comprising: at least one processor; and at least one memory including computer program code, wherein the at least one memory and the computer program code are configured to, with the at least one processor, cause the apparatus at least to: determine whether each of a first sequence of movement points and a second sequence of movement points comprises a first movement point at a first ordinal number and a second movement point at a second ordinal number within the each of the first sequence of movement points and the second sequence of movement points, wherein the first sequence of movement points and the second sequence of movement points comprise a first plurality of movement points and a second plurality of movement points of one or more body parts of the person ordered according to respective time points at which the first plurality of movement points and the second plurality of movement points are detected from a first series of video frames and a second series of video frames corresponding to a detection area, respectively; and identify, in response to a result of the determination, a start and an end of a sequence of movement points to perform the task by the person from the first sequence of movement points and/or the second sequence of movement points based on the first movement point and the second movement point.

In a third aspect, the present disclosure provides a system for identifying a task performed by a person from a series of video frames comprising the apparatus according to the second aspect and at least one video capturing apparatus configured to generate the first series of video frames and the second series of video frames.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

Embodiments of the disclosure will be better understood and readily apparent to one of ordinary skill in the art from the following written description, by way of example only, and in conjunction with the drawings.

FIG. 1 shows a diagram illustrating a conventional process for identifying assembly tasks performed by a person and checking whether the tasks are correctly done.

FIG. 2 shows a diagram illustrating a process of using multiple sample videos of assembly tasks carried out by a person in a working station for training a deep learning model for subsequent identification of the assembly tasks.

FIG. 3 shows a flow chart illustrating a method for identifying a task performed by a person from a series of video frames according to various embodiments of the present disclosure.

FIG. 4 shows a block diagram illustrating a system for identifying a task performed by a person from a series of video frames according to various embodiments of the present disclosure.

FIG. 5 shows a diagram illustrating a process for identifying a task performed by a person from a sample video according to an embodiment of the present disclosure.

FIG. 6 shows a diagram illustrating a series of tasks identified from four cycle videos four cycles of movements performed by a person, respectively, according to an embodiment of the present disclosure.

FIG. 7 shows a flow chart illustrating a process for identifying a series of tasks performed by a person from four cycle videos according to an embodiment of the present disclosure.

FIG. 8 shows a diagram illustrating detections of a turn back point according to an embodiment of the present disclosure.

FIG. 9 shows a diagram illustrating a detection area in a video frame according to an embodiment of the present disclosure.

FIG. 10 shows a table with four sequences of turn back points detected from four cycle videos according to an embodiment of the present disclosure.

FIG. 11 shows modified tables with modified sequences of turn back points from the table of FIG. 10.

FIG. 12 shows a table with identification of PIDs sets from the modified table of FIG. 11 and a diagram illustrating a distance between two movement directions according to an embodiment of the present disclosure.

FIG. 13 shows a diagram illustrating a process of estimating a start and an end of a task according to an embodiment of the present disclosure.

FIG. 14 shows a diagram illustrating a task identification process according to another embodiment of the present disclosure.

FIG. 15 shows a diagram illustrating different movement points set identified from a cycle video within a detection area according to yet another embodiment of the present disclosure.

FIG. 16 shows a diagram illustrating a sequence of movement patterns detected from a cycle video according to yet another embodiment of the present disclosure.

FIG. 17 shows a diagram illustrating an interface to review annotation data after automatic task identification is carried out according to an embodiment of the present disclosure.

FIG. 18 shows a schematic diagram of an exemplary computing device suitable for use to execute the method in FIG. 3 and implement the apparatus in FIG. 4.

### DESCRIPTION OF EXAMPLE EMBODIMENTS

Embodiments of the present disclosure will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “receiving”, “calculating”, “determining”, “updating”, “generating”, “initializing”, “outputting”, “receiving”, “retrieving”, “identifying”, “dispersing”, “authenticating” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

Various embodiments of the present disclosure relate to a method and an apparatus for identifying a task performed by a person from a series of video frames generated by at least one video capturing apparatus. It is appreciated by a skilled person that such apparatus and the at least one video capturing apparatus may be implemented as part of a system to provide the same technical effect.

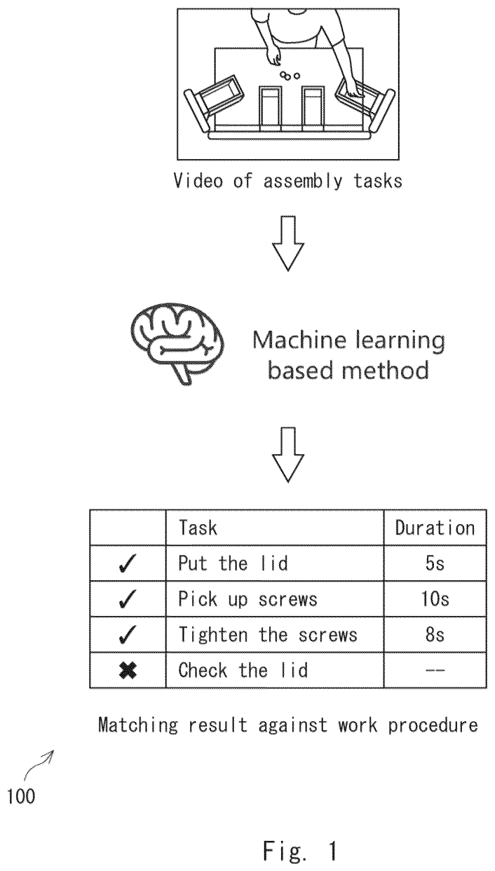

FIG. 1 shows a diagram 100 illustrating a conventional process for identifying assembly tasks performed by a person and checking whether the tasks are correctly done. Conventionally, a video of the assembly tasks is processed by a machine learning based method to generate a tabulated result. The result contains a series of assembly tasks, such as tasks to put the lid, pick up screws, tighten the screws and check the lid, identified from the video by the machine learning based method with respective durations for completing each of the assembly tasks. Such result is then matched against a work procedure with standard durations for completing each of the assembly tasks to identify whether the tasks performed by the person are correctly done. In this example, the tasks of putting the lid, picking up screws and tightening the screws are identified as correctly done based on the durations whereas the task of checking the lid is not detected and therefore is identified as not done correctly.

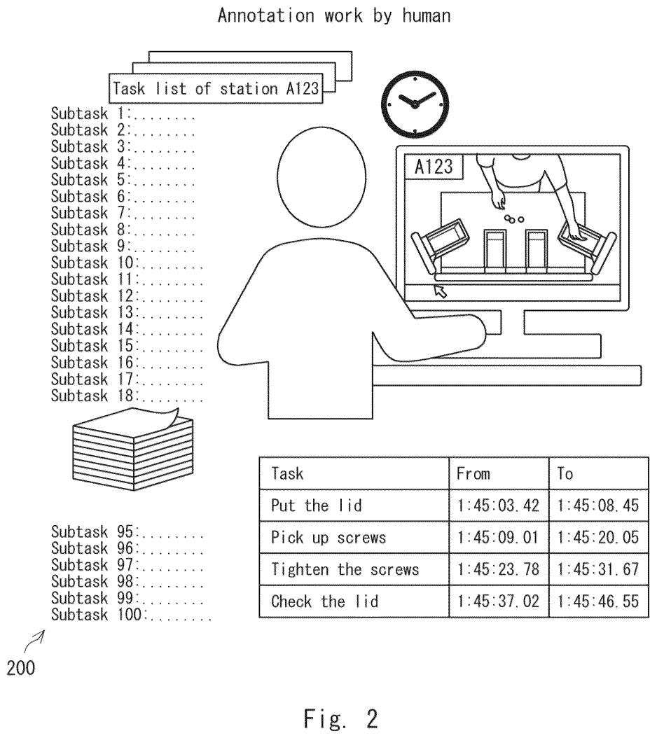

FIG. 2 shows a diagram 200 illustrating a process of using multiple sample videos of assembly tasks carried out by a person in a working station (A123) for training a deep learning model for subsequent identification of the assembly tasks. As mentioned above, it is required to train the deep learning model with “correct answers” in order for deep learning model to subsequently identify and check if the assembly tasks are correctly done or not. Conventionally, the user is required to manually annotate each task or subtask from each sample video to generate a task list of the working station. The tabulated result of annotation work from a sample video is shown in table 208. In case of a number of tasks at one station may exceed 100, such annotation work to annotate each task from each sample video may take ridiculously long time to complete, thus preventing users from introducing deep learning models for assembly tasks identification.

It is thus an object to provide a method, an apparatus and a system for identifying a task performed by a person from a series of video frames to address the above challenges by automatically generate a start timing and an end timing of each task of a series of task in a sample video to eliminate such annotation workload.

According to the present disclosure, the method, apparatus and system may use movement patterns of a body part of a person, detected from a video of assembly tasks to generate training data and discover tasks by looking at stay points, turn back points, short paths which are common observed over sample cycles. In various embodiments below, hand movement points or patterns detected from a video of assembly tasks within a detection area such as working station are used for assembly task identification because hands are commonly seen and used in typical assembly scene and pre-trained model can also be used. Advantageously, such method, apparatus and system provides a solution which keeps manual annotation work small, minimize the need to refer to work procedure document and reduce the hurdle in adopting deep leaning based solution for such assembly task identification.

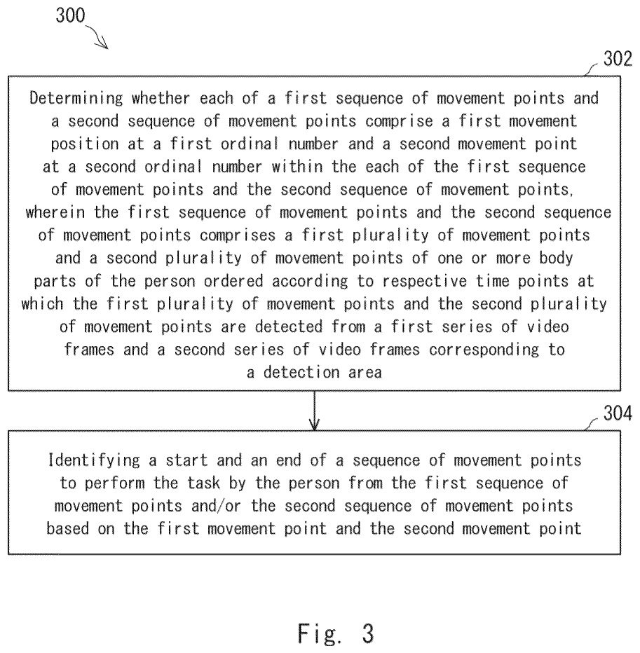

FIG. 3 shows a flow chart 300 illustrating a method for identifying a task performed by a person from a series of video frames according to various embodiments of the present disclosure. In step 302, a step of determining whether each of a first sequence of movement points and a second sequence of movement points comprises a first movement point at a first ordinal number and a second movement point at a second ordinal number within the each of the first sequence of movement points and the second sequence of movement points is carried out, where the first sequence of movement points and the second sequence of movement points comprise a first plurality of movement points and a second plurality of movement points of one or more body parts of the person ordered according to respective time points at which the first plurality of movement points and the second plurality of movement points are detected from a first series of video frames and a second series of video frames corresponding to a detection area. In step 304, a step of identifying a start and an end of a sequence of movement points to perform the task by the person from the first of movement points and/or the second sequence of movement points are carried out based on the first movement point and the second movement point.

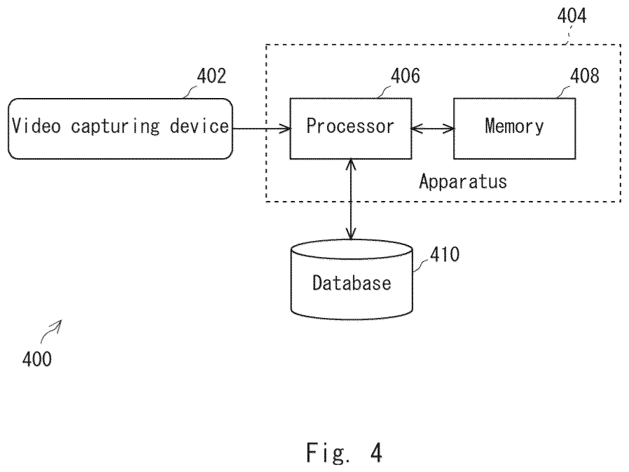

FIG. 4 shows a block diagram illustrating a system 400 for identifying a task performed by a person from a series of video frames according to various embodiments of the present disclosure.

The managing of image or video input is performed by at least one video capturing device 402 and an apparatus 404. For the sake of simplicity, only one video capturing device 402 is illustrated. The system 400 comprises a video capturing device 402 in communication with the apparatus 404. In an implementation, the apparatus 404 may be generally described as a physical device comprising at least one processor 406 and at least one memory 408 including computer program code. The at least one memory 408 and the computer program code are configured to, with the at least one processor 406, cause the physical device to perform the operations described in FIG. 3. The processor 406 is configured to receive one or more input videos from the video capturing device 402 or retrieve one or more videos from a database. Alternatively or additionally, the one or more videos captured by the video capturing device 402 is stored in a database 410, and the processor 406 is configured to retrieve the one or more videos from the database 410.

The video capturing device 402 may be a device such as a closed-circuit television (CCTV) which provides a variety of data such as data relating to an appearance and/or a movement of one or more body part of a person to identify a task performed by the person. In an implementation, appearance data derived from the video capturing device 402 may be stored in memory 408 of the apparatus 404 or a database 410 accessible by the apparatus 404. The data may include (i) facial feature data such as relative position, size, shape and/or contour of eyes, nose, cheekbones, jaw and chin, and also iris pattern, skin colour, hair colour or a combination thereof, (ii) physical characteristic data such as height, body size, body ratio, length of limbs, hair colour, skin colour, apparel, belongings, other similar characteristics or combinations, and (iii) behavioral characteristic data such as body movement, position of limbs, direction of movement, differential in movement direction, moving speed, frequency, movement patterns, the way or the time period a person or his/her body part stay stills or moves, other similar characteristics or combinations.

In an implementation, camera data such as location and resolution, and/or time data which includes a timestamp at which the one or more persons are identified may also be derived from the video capturing device 402. The camera data and/or time data may be stored in memory 408 of the apparatus 404 or a database 410 accessible by the apparatus 404 and the processor 406 is configured to identify and retrieve data or video based on the time data. It should be appreciated that the database 410 may be a part of the apparatus 404.

The apparatus 404 may be configured to communicate with the video capturing device 402 and the database 410. In an example, the apparatus 404 may receive, from the video capturing device 402, or retrieve from the database 410, multiple videos, each having a series of video frames relating to a detection area (corresponding to a field of view of the video capturing device 402) onto an assembly task working station, as input, and after processing by the processor 406 in apparatus 404, generate an output relating to an identification of a task or a series of tasks performed by a person from the one or more videos. Such output may then be used to subsequently train a deep learning model to identify at task or series of tasks performed by a person from a video.

According to the present disclosure, after receiving a first series of video frames or a second series of video frames, which can be derived from a single video file or separate video files, from the video capturing device 402, or retrieve the first and second series of video frames from the database 410, the memory 408 and the computer program code stored therein are configured to, with the processor 406 cause the apparatus 404 to determine whether each of a first sequence of movement points and a second sequence of movement points comprises a first movement point at a first ordinal number and a second movement point at a second ordinal number within the each of the first sequence of movement points and the second sequence of movement points,

The first sequence of movement points and the second sequence of movement points comprise a first plurality of movement points and a second plurality of movement points of one or more body parts of the person ordered according to respective time points at which the first plurality of movement points and the second plurality of movement points are detected from a first series of video frames and a second series of video frames corresponding to a detection area, respectively.

The memory 408 and the computer program code stored therein are configured to, with the processor 406 cause the apparatus 404 may be configured to, in response to a result of the determination, identify a start and an end of a sequence of movement points to perform the task by the person from the first sequence of movement points and/or the second sequence of movement points based on the first movement point and the second movement point.

In an embodiment, where the first sequence of movement points comprises the first movement point at a third ordinal number which is an ordinal number count away from the first ordinal number within the first sequence of movement points, the memory 408 and the computer program code stored therein are configured to, with the processor 406 cause the apparatus 404 to increase the third ordinal number of the first movement point and ordinal numbers of subsequent movement points within the first sequence of movement points by the ordinal number count to shift the first movement point to be at the first ordinal number of the first sequence of movement points (while the subsequent movement points be at ordinal numbers of the first sequence of movement points following the first ordinal number), and determine whether the each of the first sequence of movement points and the second sequence of movement points comprises the first movement point at the first ordinal number and the second movement point at the second ordinal number within the each of the first sequence of movement points and the second sequence of movement points after the increment/shift.

In an embodiment, where the first sequence of movement points comprises a third movement point at the first ordinal number, the memory 408 and the computer program code stored therein are configured to, with the processor 406 cause the apparatus 404 to determine whether the third movement point is within a threshold distance from the first movement point; and determine, whether the each of the first sequence of movement points and the second sequence of movement points comprises the first movement point or the third movement point at the first ordinal number and the second movement point at the second ordinal number within the each of the first sequence of movement points and the second sequence of movement points.

In another embodiment, the memory 408 and the computer program code stored therein are configured to, with the processor 406 cause the apparatus 404 to detect the one or more body parts of the person at a portion of the detection area in each video frame of each of the first and second series of video frames; and assign a movement point corresponding to the portion of the detection area in the each video frame of the each of the first and second series of video frames. Additionally, in such embodiment, the memory 408 and the computer program code stored therein are configured to, with the processor 406 cause the apparatus 404 to determine if a first portion of the detection area in a first video frame of one of the first and second of video frames and a second portion of the detection area in a second video frame of the one of the first and second series of video frames are both within one of a plurality of smaller detection areas of the detection area, each of the plurality of smaller detection areas occupying different x- and y-coordinates within the detection area; and assign a single movement point corresponding to the first and second portions of the detection area.

In yet another embodiment, the memory 408 and the computer program code stored therein are configured to, with the processor 406 cause the apparatus 404 to detect a switch in a movement direction (hereinafter may referred to as a change of direction) of the one or more body parts of the person at the portion of the detection area in the each video frame of the each of the first and second series of video. Additionally, under this yet another embodiment, the memory 408 and the computer program code stored therein are configured to, with the processor 406 cause the apparatus 404 to determine if an angle between a previous movement direction of the one or more body parts of the person detected at a previous time point prior to the time point at which one or more body parts of the person is detected at the portion of the detection area and a subsequent movement direction of the one or more body parts of the person detected at a subsequent time point after the time point at which one or more body parts of the person is detected at the portion of the detection area is larger than a threshold angle, detect the switch in the movement direction of the one or more body parts of the person based on a result of the determination of the angle.

In one embodiment, the memory 408 and the computer program code stored therein are configured to, with the processor 406 cause the apparatus 404 to determine if the one or more body parts of the person is stationary or with a movement within a time period at the portion of the detection area in the each video frame of the each of the first and second series of video frames; assign the movement point corresponding to the portion of the detection area based on a result of the determination of the one or more body parts of the person.

In another embodiment, the memory 408 and the computer program code stored therein are configured to, with the processor 406 cause the apparatus 404 to determine whether the each of the first sequence of movement points and the second sequence of movement points comprises a first movement pattern and a second movement pattern within the each of the first sequence of movement points and the second sequence of movement points, and identify the start and the end of the sequence of movement points to perform the task by the person in response to the result of the determination is based on the first movement pattern and the second movement pattern.

In yet another embodiment, the memory 408 and the computer program code stored therein are configured to, with the processor 406 cause the apparatus 404 to extract first data and second data relating to the one or more body parts of the person performing the sequence of movement points from the first sequence of movement points and the second sequence of movement points, respectively; and display at least a part of the first data not present in the second data and a part of the second data not present in the first data in different colours over the detection area.

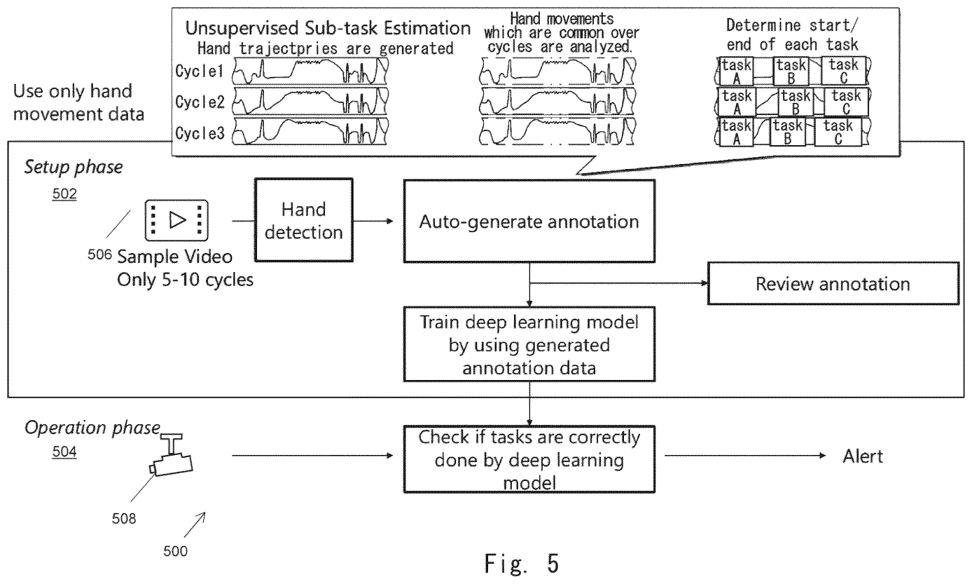

FIG. 5 shows a diagram 500 illustrating a process for identifying a task performed by a person from a sample video according to an embodiment of the present disclosure. The process may be divided into setup phase 502 where sample videos are input to train a deep learning model to perform identification of a task or a series of tasks performed by a person and an operation phase 504 where the trained model is then used to subsequently identify the task or series of tasks, or similar task or series of similar tasks, performed by the person or another person.

During the setup phase 502, a sample video 506 containing 5-10 cycles of movements of one or more persons is processed by performing hand detection. A series of tasks (e.g., task A, task B, task C) are identified each cycle of movement based on the hand detection results. Annotation data of each task on the sample video is also automatically generated. Such annotation data is then used to train deep learning model. Subsequently, at operation phase 504, a video (or a series of video frames) is obtained from a camera 508 and processed by the trained deep learning model to check and identify the same task or series of tasks, or similar task or series of similar tasks, performed by the person or another person. In an event that the deep learning model identifies that the series tasks are not correctly done, an alert may be generated to alert the user.

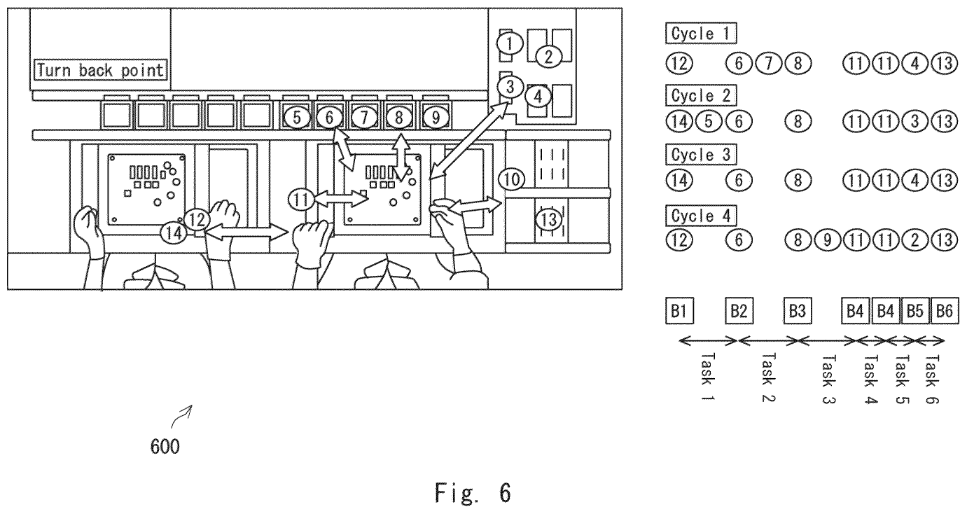

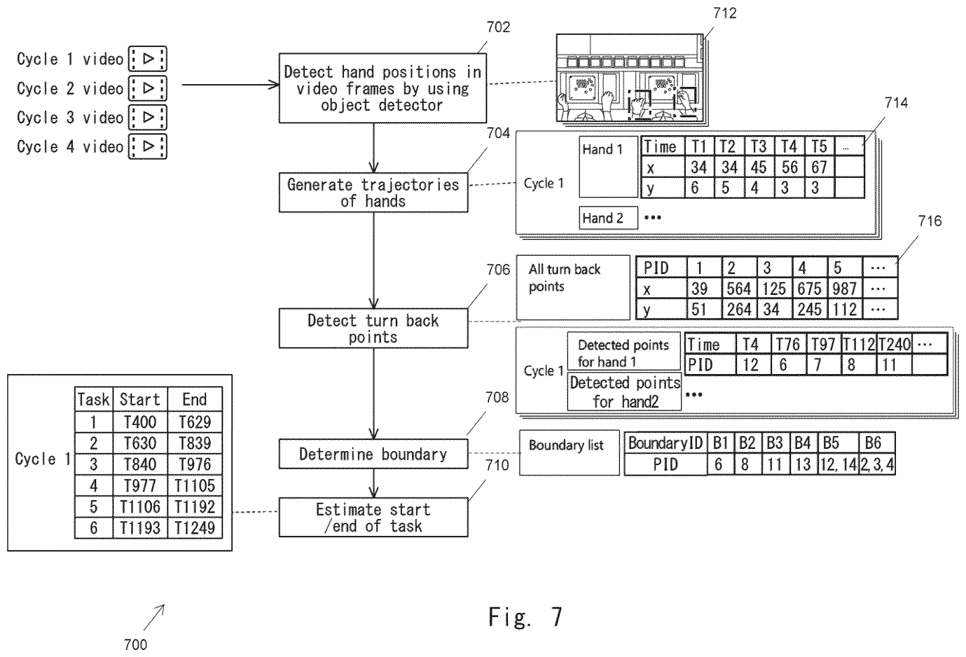

FIG. 6 shows a diagram 600 illustrating a series of tasks identified from four cycle videos four cycles of movements (cycle 1, cycle 2, cycle 3, cycle 4) performed by a person, respectively, according to an embodiment of the present disclosure. FIG. 7 shows a flow chart 700 illustrating a process for identifying a series of tasks performed by a person from four cycle videos according to an embodiment of the present disclosure. It is appreciated that two or more cycles of movements may be obtained from a single sample video (or series of video frames).

The four cycle videos each having a series of video frames covering a same detection area 712 and the following steps are carried out on each cycle videos (series of video frames) to identify a series of tasks performed by a person. In step 702, a step of detecting hand positions at a portion, part of point (with x-y coordinates) within the detection area 712 in the video frames (corresponding to the field of video of the camera) is carried out using object detector. In step 704, when various hand positions are detected across times, the trajectories of the hands are generated, tracking the movements of the hands of the person. An example table 714 indicating the trajectories (e.g., x-y coordinates) of a hand (e.g., right hand) of a person detected from cycle 1 video is illustrated. In step 706, a step of detecting movement points is carried out. In this embodiment, a turn back movement of a hand is identified as a movement point, as shown in an example table 716. Various movement (turn back) points of the person's hands within the detection area in the video frames are detected from each cycle video. The detected movement points of the person's hands from each cycle video are ordered according to the time points of the video frames at which the movement points are detected, forming a sequence of movement points.

In various embodiments below, a movement point identifier (e.g., position/point identifier (PID)) identifying specific x-y coordinates in the detection area in the video frames may be assigned to each specific movement point detected within the detection area, and a same movement point identifier may be assigned to the same movement point of the same detection area in different series of video frames for different cycles of movements. For sake of simplicity, hereinafter, a movement point identifier is used to represent a movement point while its correspondence to x-y coordinates in the detection area is omitted.

Table 1 shows four sequences of movement points (in this case, turn back points) detected from four different cycles of movements (Cycle 1, Cycle 2, Cycle 3, Cycle 4). Each sequence is formed by ordering the movement points detected from a cycle of movement (series of video frames) according to the time points of video frames at which they are detected or orders in which they are performed by the person to form the sequence. In particular, the first detected movement point from the cycle of movement will be in the first term (ordinal number “1” or “1st”) of the sequence, the immediate movement point detected after the first detected movement point will be in the second term (ordinal number “2” or “2nd”) of the sequence, and so on. In this embodiment, all four sequences have ten terms from 1st to 10th.

| | 1^{st} | 2^{nd} | 3^{rd} | 4^{th} | 5^{th} | 6^{th} | 7^{th} | 8^{th} | 9^{th} | 10^{th} |
|---|---|---|---|---|---|---|---|---|---|---|
| Cycle 1 | 12 | — | 6 | 7 | 8 | — | 11 | 11 | 4 | 13 |
| Cycle 2 | 14 | 5 | 6 | — | 8 | — | 11 | 11 | 3 | 13 |
| Cycle 3 | 14 | — | 6 | — | 8 | — | 11 | 11 | 4 | 13 |
| Cycle 4 | 12 | — | 6 | — | 8 | 9 | 11 | 11 | 2 | 13 |

According to the present disclosure, the movement points at one ordinal number across all sequences (cycles) are compared, to check if they all share a same movement point at the same ordinal number of the sequences. For example, it is determined and identified that all four sequences have movement point IDs “6’ at the 3rd term, “8” at 5th term, “11” at 7th term”, “11” at 8th term and “13” at 10th term. In addition, it is determined that if two or more movement points are close to each other, i.e., within a threshold distance with each other, they may form a movement points set which may be treated as a single movement point for further processing. For example, when it is determined that the set of movement points “₁₂” and “14” at 1st term are within threshold distance with each other, so does the set of movement point “3” and “4” at 9th term, it is identified that all four sequences also have a same movement point at 1st term and 9th term, respectively.

Subsequently, in step 708, a step of determining a task boundary is carried out. In particular, each term with a same movement point ID across all four sequences is identified as a task boundary and assigned a boundary ID. In this case, the terms in ordinal number 1, 3, 5, 7, 8, 9, 10 are assigned to boundary IDs “B1”, “B2”, “B3”, “B4”, “B4”, “B5”, “B6” respectively. In step 710, a step of estimating a start and an end of a task is carried out. In particular, the boundaries and the time points or duration are then used to define a start and an end of a task. For example, the movement points from boundary IDs “B1” and “B2” (terms 1-3) are identified under task 1, the movement points from boundary IDs “B2” and “B3” (terms 3-5) are identified under task 2, the movement points from boundary IDs “B3” and “B4” (terms 5-7) are identified under task 3, the movement points from two boundary IDs “B4” and “B4” (terms 7-8) are identified under task 4; the movement points from boundary IDs “B4” and “B5” (terms 8-9) are identified under task 5; and the movement points from boundary IDs “B5” and “B6” (terms 9-10) are identified under task 6.

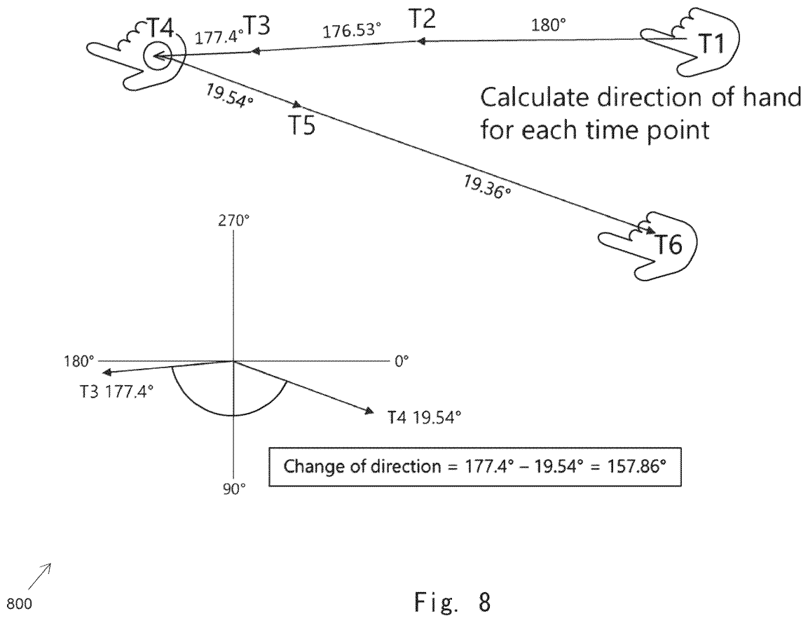

FIG. 8 shows a diagram 800 illustrating detections of a turn back point according to an embodiment of the present disclosure. When processing a video covering a detection area, a position (e.g., x-y coordinates) of a hand within the detection area is obtained at each time point (e.g., T1-T6) of the video. A hand movement direction (in term of an angle relative to x-axis) can be calculated for each time point by taking the hand positions of the time point and previous time points. For example, the hand movement direction from the hand position at T1 to the hand position at T2 is 180°; from the hand position at T2 to the hand position at T3 is 176.53°; from the hand position at T3 to the hand position at T4 is 177.4°; from the hand position at T4 to the hand position at T5 is 19.54°; from the hand position at T5 to the hand position at T6 is 19.36°.

According to the present disclosure, a turn back point is detected when there is a switch in the movement directions, i.e., when there is change of movement direction. In one example, a change of direction is detected when the difference between a movement direction at Ti and its previous movement direction at Ti−1, in term of their angles relative to x-axis, is larger than a threshold angle (e.g., the movement direction at Ti, or larger than 90°). For example, the difference between the movement directions at T3 and T4 is 157.86°, larger than the movement direction at T4, therefore a change of direction is detected at T4.

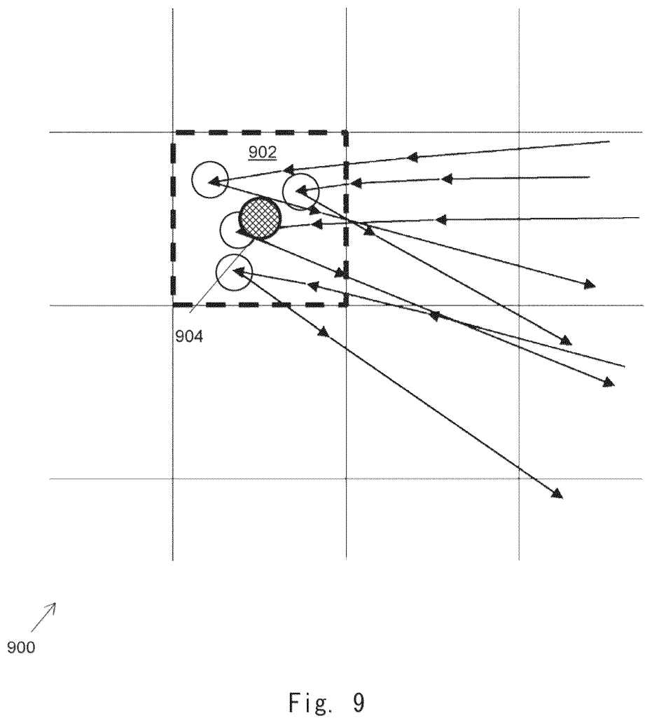

FIG. 9 shows a diagram 900 illustrating a detection area in a video frame according to an embodiment of the present disclosure. The detection area in video frames is sub-divided into a plurality of smaller detection areas, forming a grid, each smaller detection area occupying a different x- and y-coordinates within the detection area. If multiple movement points, in this case turn back points, are determined within the same smaller detection area 902, a single turn back point 904 is created and assigned to represent all of them.

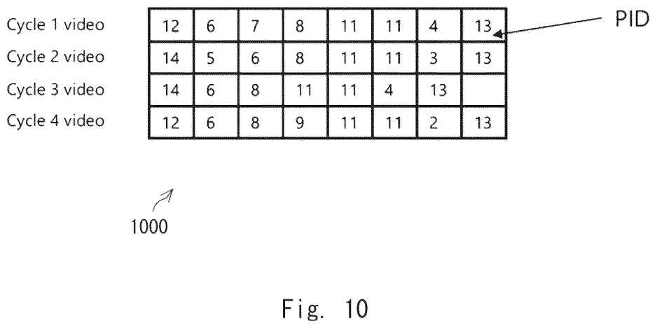

FIG. 10 shows a table 1000 with four sequences of turn back points detected from four cycle videos according to an embodiment of the present disclosure. The movement points (turn back points) occurred and detected within the detection area in the videos are illustrated using the PIDs. FIG. 1I shows modified tables 1102, 1104 with modified sequences of turn back points from the table of FIG. 10. In this embodiment, it is determined that the PID “6” is not align across all four sequences. In particular, the PID “6” is at the 3rd term or cell (ordinal number three) of the sequence obtained from cycle 2 video whereas it is at the 2nd term or cell (ordinal number two) of the sequences obtained from the cycle 1, 3 and 4 videos. There is a 1 term number count difference (or ordinal number count difference) in the terms (or ordinal number) between the PID “6” in the cycle 2 video sequence and those in the cycle 1, 3, and 4 video sequences. The PID “6” in the sequences of cycle 1, 3 and 4 videos are shifted and moved back for the same term (ordinal) number count such that the same PID “6” is aligned across all the sequences (present in the same column of the table). Accordingly, the sequence length (i.e., the total number of the movement points) of the sequences of cycle 1, 3 and 4 videos, where the shifting is carried out, are increased by the same term (ordinal) number count.

The same shifting process is carried out on respective sequences to align PIDs “8”, “11”, “11” and “13” at the 3rd, 5th, 7th, 8th, and 10th terms, respectively, across all sequences. For each term (or ordinal number) having the same PIDs, the PID is added to a boundary list.

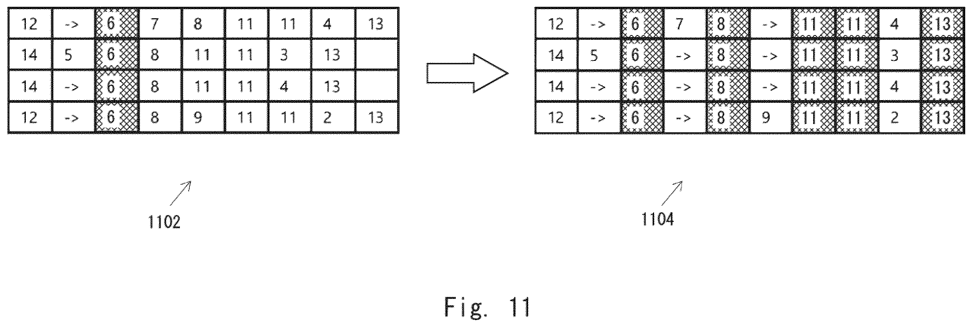

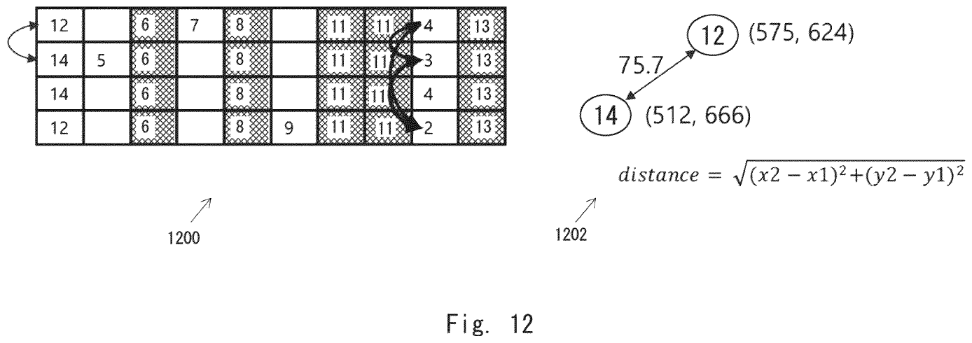

FIG. 12 shows a table 1200 with identification of PIDs sets from the modified table of FIG. 11 and a diagram 1202 illustrating a distance between two PIDs according to an embodiment of the present disclosure. When different PIDs are present at the same term of different sequences, for example, the 1st term of cycle 1 and 4 videos is PID “12” and cycle 2 ad 3 videos is PID “14”, the distance between the two PIDs, for example, the difference in the x-y coordinates within the detection area, is calculated and determine if the calculated distance are close to each other and within a threshold distance. The x-y coordinates within the detection area corresponding to the PIDs are used to calculate the distance between the two PIDs, for example, using the following equation (1):

$$Distance = \sqrt{{( x 2 - x 1 )}^{2} + {( y 2 - y 1 )}^{2}} \qquad equation ( 1 )$$

where the two PIDs have a x-y coordinates of (x1, y1) and (x2, y2), respectively.

For example, it is determined that the 1st term of cycle 1 and 4 videos of PID “12” and that of cycle 2 and 3 videos of PID “14” are different. The distance between PIDs “12” and “14” is calculated using equation 1. In this case, PID “12” has a x-y coordinate of (575, 624) and PID “14” has a x-y coordinate of (512, 666). The distance between the two PIDs is 75.7, within a threshold distance. Therefore, the set of PIDs {12, 14} is also added to the boundary list. The same applies to the 9th term of the sequences with PIDs “2”, “3” and “4”. As they are all within a threshold distance among one another, they form a PID set and added to the boundary list.

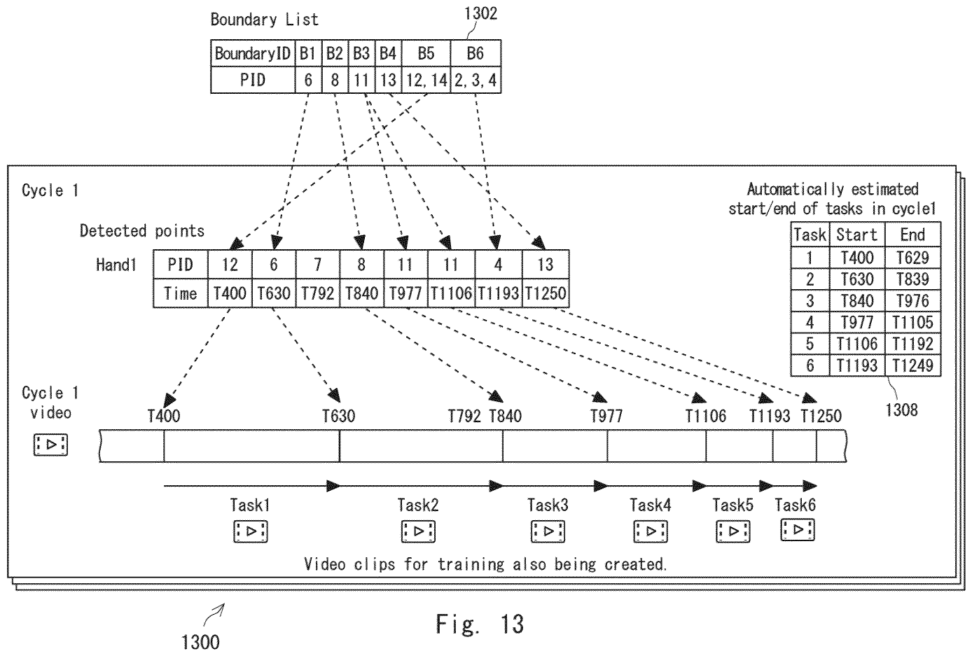

FIG. 13 shows a diagram 1300 illustrating a process of estimating a start and an end of a task according to an embodiment of the present disclosure. After the boundary list is formed, each PID or PID set in the boundary list will be assigned a boundary ID, as shown in table 1302. The PIDs in each sequence of PIDs are then checked if they exist in the boundary list. The time points of the video when the PIDs are detected are then used to identify and annotate a start and an end of a task.

For example, the PIDs in the sequence obtained from cycle 1 video are checked against the boundary list. It is identified that the PIDs “12”, “6”, “8”, “11”, “11”, “4”, “13” in the sequence are present and matched with the PIDs in the boundary list under boundary IDs “B5”, “B1”, “B2”, “B3”, “B3”, “B6”, “B4”, respectively. The time points when such matching PIDs, which are present in the boundary list, are detected are then used to determine a start and an end of a task. In particular, the first time point T400 at which a matching PID “12” is detected and the time point T629 just before the time point T630 at which the next matching PID “6” is detected are used to set a start and an end of the first task, task 1. Similarly, the second time point T630 at which the second matching PID “6” is detected and the time point T791 just before the time point T840 at which the next matching PID “8” is detected are used to set a start and an end of the next task, task 2. The third time point T840 at which the third matching PID “8” is detected and the time point T976 just before the time point T977 at which the next matching PID “11” is detected are used to set a start and an end of the next task, task 3. The same applies automatically to estimate the start and the end of each task in cycle 1, thereby forming a series of tasks with 6 tasks, as shown in table 1308.

In an alternative embodiment, movement points may collectively form an area or region within the detection area based on proximity of the movement points relative to other movement points and other properties such as type of movement (e.g., turn back movement, stay without movement, stay with slight movement) and stay period (e.g., immediate turn back with no stay period, turn back after a stay period). Therefore, unlike a grid, different areas may be separate and discontinuous between each other. In such embodiment, the detections of movement points of hands are then based on the transitions and movements from one area to another area.

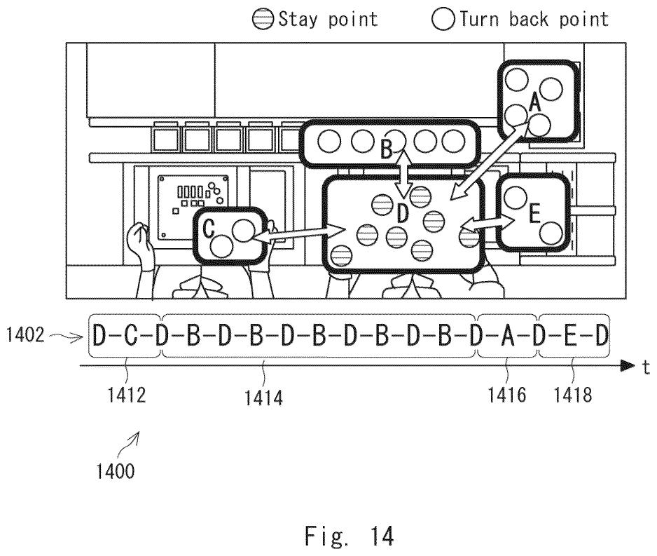

FIG. 14 shows a diagram 1400 illustrating a task identification process according to another embodiment of the present disclosure. The detection area can be divided into five separate areas, areas A-E. Areas A, B, C and E each contain turn back points which are close to each other whereas area D contains only stay points where the hands are detected to be staying at the points a predetermined amount or period of time. The transition of the hands between areas and the sequence of the transition are recorded as shown in the sequence 1402. In one example, a task is identified when there is movements between the stay points area D and a turn back points area (e.g., area C) and another task is identified when there is a switch of the movements to be between the stay points area D and another turn back points area (e.g., area B, A or E). In particular, the time period 1412 when movements between areas D and C occurred are identified as the start and the end of task 1, the subsequent time period 1414 where movements between areas D and B occurred are identified as the start and the end of task 2; the subsequent time period 1416 where movements between areas D and A occurred are identified as the start and the end of task 3; and the subsequent time period 1418 where movements between areas A and E occurred are identified as the start and the end of task 4.

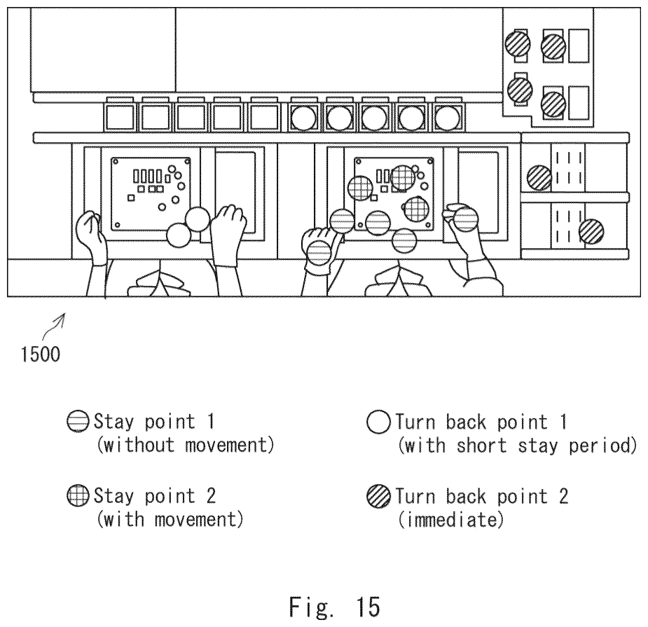

In yet another embodiment, movement points detected from a cycle video can be further categorized based on certain type of movement and stay period under the same movement points set and the detection of movement points of hands are then based on the transition and movements from one movement points set to another movement points set. FIG. 15 shows a diagram 1500 illustrating different movement points set identified from a cycle video within a detection area according to yet another embodiment of the present disclosure. Four different movement points set (type) are identified from the cycle video, namely stay point where the hands stay without movement such as palm contact to working desk, stay point 2 where the hand stay with slight movement such as tightening screw, turn back point 1 where the hands turn back after a short stay period such as picking up small screw, and turn back point 2 where the hands turn back immediately with almost no stay period such as grabbing a large part or pushing a button.

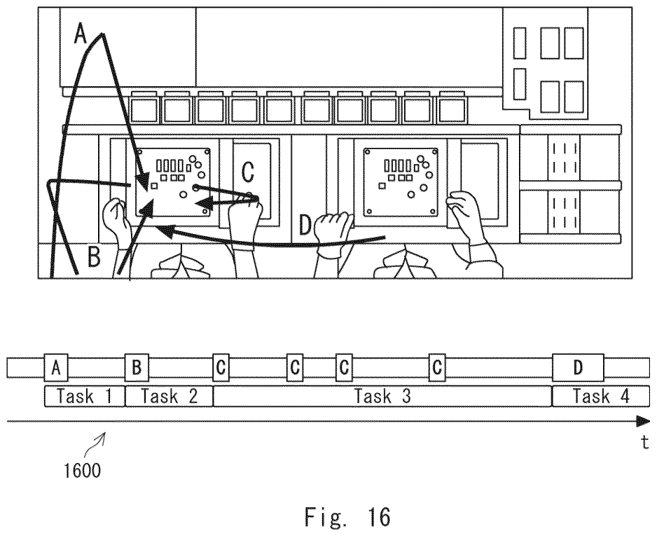

In yet another embodiment, a movement pattern may be detected based on multiple detected movement points, and a task may be identified based on a sequence of movement patterns. FIG. 16 shows a diagram 1600 illustrating a sequence of movement patterns detected from a cycle video according to yet another embodiment of the present disclosure. A sequence of movement patterns A, B, C, C, C, C, D is detected. In one example, a task is identified and created based on one movement pattern and another task is identified and creased when a different movement pattern is detected. In this case, the period from the time point at which the movement pattern A is detected till the time point at which the movement pattern B is detected is identified as the start and the end of task 1; the time period from the time point at which the movement pattern B is detected till the time point at which the movement pattern C is detected is identified as the start and the end of task 2, the time period from the time point at which the movement pattern is first detected till the time point at which a different movement pattern, movement pattern D, is detected is identified as the start and the end of task 3, and the remaining time after the movement pattern D is detected till the end of the cycle video is identified as the start and the end of task 4.

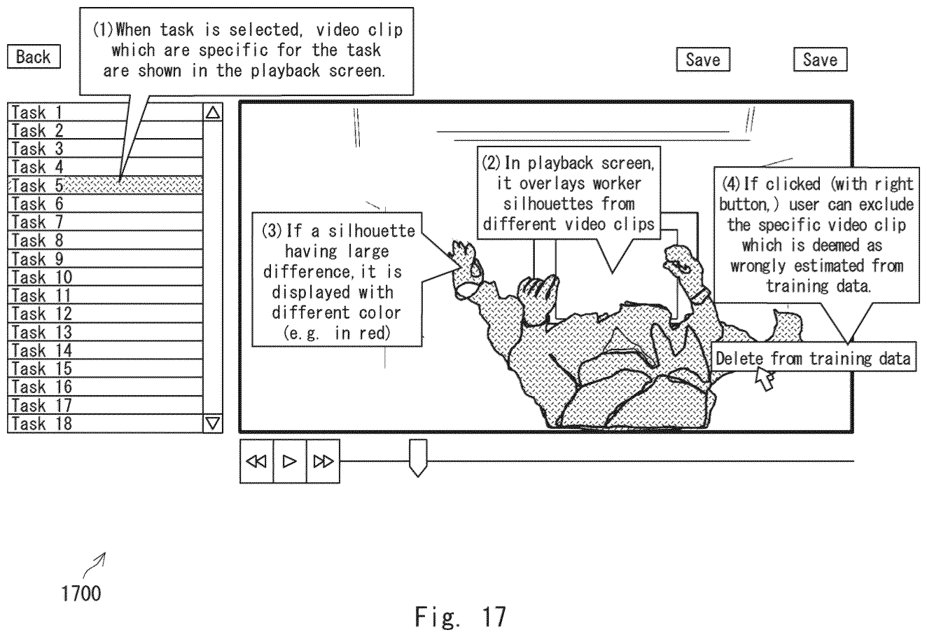

FIG. 17 shows a diagram 1700 illustrating an interface to review annotation data after automatic task identification is carried out according to an embodiment of the present disclosure. A series of 18 tasks (Tasks 1-18) are identified from multiple sample videos with multiple cycle of movements. A user may select a task of interest, for example task 5, and a video clip which is specific to the selected task are shown in the playback screen. In one example, the video clips of all sample videos annotated under task 5 are displayed in the playback screen and the data relating to worker silhouettes from different video clips are extracted and overlaid. If it is detected that a silhouette from one sample video has a large difference from silhouette from other sample videos in which the worker is performing the same task, for example, the data relating to the worker silhouette in one video clip is not present in the data relating to the worker silhouette in other video clips and the amount of the data in the video clip not present in the other video clips is larger than a threshold amount, it is displayed with different color (e.g., in red). The user may exclude the specific video clip which is deemed as wrongly estimated from the training sample videos to improve the annotation and task identification results.

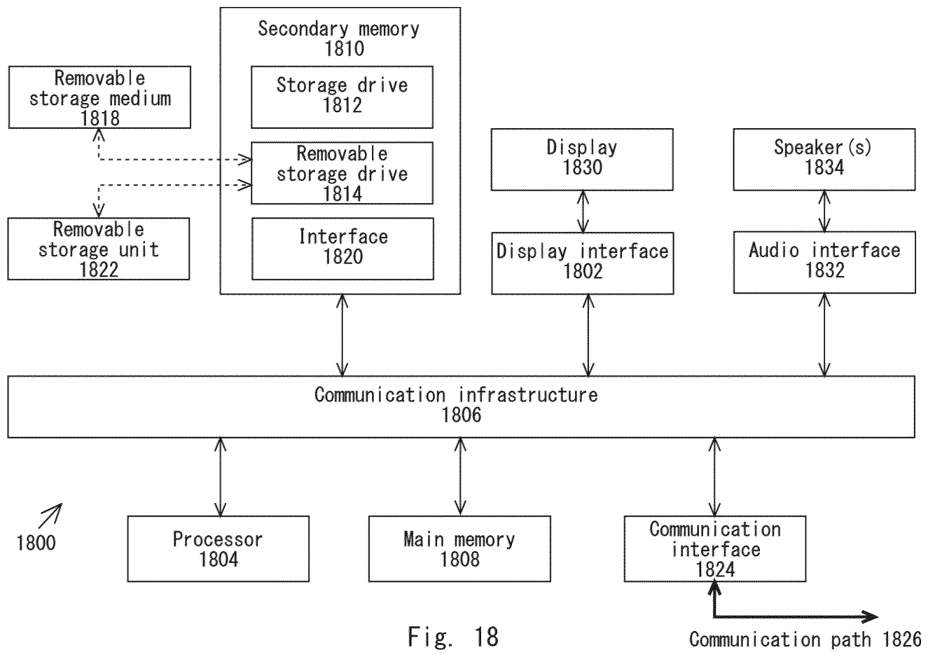

FIG. 18 shows a schematic diagram of an exemplary computing device 1800, hereinafter interchangeably referred to as a computer system 1800, where one or more such computing device 1800 may be used or suitable for use to execute the method in FIG. 3 and implement the apparatus in FIG. 4. The following description of the computing device 1800 is provided by way of example only and is not intended to be limiting.

As shown in FIG. 18, the example computing device 1800 includes a processor 1804 for executing software routines. Although a single processor is shown for the sake of clarity, the computing device 1800 may also include a multi-processor system. The processor 1804 is connected to a communication infrastructure 1806 for communication with other components of the computing device 1800. The communication infrastructure 1806 may include, for example, a communications bus, cross-bar, or network.

The computing device 1800 further includes a main memory 1808, such as a random access memory (RAM), and a secondary memory 1810. The secondary memory 1810 may include, for example, a storage drive 1812, which may be a hard disk drive, a solid state drive or a hybrid drive and/or a removable storage drive 1814, which may include a magnetic tape drive, an optical disk drive, a solid state storage drive (such as a USB flash drive, a flash memory device, a solid state drive or a memory card), or the like. The removable storage drive 1814 reads from and/or writes to a removable storage medium 1818 in a well-known manner. The removable storage medium 1818 may include magnetic tape, optical disk, non-volatile memory storage medium, or the like, which is read by and written to by removable storage drive 1814. As will be appreciated by persons skilled in the relevant arts, the removable storage medium 1818 includes a computer readable storage medium having stored therein computer executable program code instructions and/or data.

In an alternative implementation, the secondary memory 1810 may additionally or alternatively include other similar means for allowing computer programs or other instructions to be loaded into the computing device 1800. Such means can include, for example, a removable storage unit 1822 and an interface 1820. Examples of a removable storage unit 1822 and interface 1820 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 1822 and interfaces 1820 which allow software and data to be transferred from the removable storage unit 1822 to the computer system 1800.

The computing device 1800 also includes at least one communication interface 1824. The communication interface 1824 allows software and data to be transferred between computing device 1800 and external devices via a communication path 1826. In various embodiments of the present disclosure, the communication interface 1824 permits data to be transferred between the computing device 1800 and a data communication network, such as a public data or private data communication network. The communication interface 1824 may be used to exchange data between different computing devices 1800 which such computing devices 1800 form part an interconnected computer network. Examples of a communication interface 1824 can include a modem, a network interface (such as an Ethernet card), a communication port (such as a serial, parallel, printer, GPIB, IEEE 1394, RJ45, USB), an antenna with associated circuitry and the like. The communication interface 1824 may be wired or may be wireless. Software and data transferred via the communication interface 1824 are in the form of signals which can be electronic, electromagnetic, optical or other signals capable of being received by communication interface 1824. These signals are provided to the communication interface via the communication path 1826.

As shown in FIG. 18, the computing device 1800 further includes a display interface 1802 which performs operations for rendering images to an associated display 1830 and an audio interface 1832 for performing operations for playing audio content via one or more associated speakers 1834.

As used herein, the term “computer program product” may refer, in part, to removable storage medium 1818, removable storage unit 1822, a hard disk installed in storage drive 1812, or a carrier wave carrying software over communication path 1826 (wireless link or cable) to communication interface 1824. Computer readable storage media refers to any non-transitory, non-volatile tangible storage medium that provides recorded instructions and/or data to the computing device 1800 for execution and/or processing. Examples of such storage media include magnetic tape, CD-ROM, DVD, Blu-ray Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 1800. Examples of transitory or non-tangible computer readable transmission media that may also participate in the provision of software, application programs, instructions and/or data to the computing device 1800 include radio or infra-red transmission channels as well as a network connection to another computer or networked device, and the Internet or Intranets including e-mail transmissions and information recorded on Websites and the like.

The computer programs (also called computer program code) are stored in main memory 1808 and/or secondary memory 1810. Computer programs can also be received via the communication interface 1824. Such computer programs, when executed, enable the computing device 1800 to perform one or more features of embodiments discussed herein. In various embodiments, the computer programs, when executed, enable the processor 1804 to perform features of the above-described embodiments. Accordingly, such computer programs represent controllers of the computer device 1800.

Software may be stored in a computer program product and loaded into the computing device 1800 using the removable storage drive 1814, the storage drive 1812, or the interface 1820. The computer program product may be a non-transitory computer readable medium. Alternatively, the computer program product may be downloaded to the computer system 1800 over the communications path 1826. The software, when executed by the processor 1804, causes the computing device 1800 to perform the necessary operations to execute the method as shown in FIG. 3 and implement the apparatus in FIG. 4.

It is to be understood that the embodiment of FIG. 18 is presented merely by way of example to explain the operation and structure of the apparatus 400. Therefore, in some embodiments one or more features of the computing device 1800 may be omitted. Also, in some embodiments, one or more features of the computing device 1800 may be combined together. Additionally, in some embodiments, one or more features of the computing device 1800 may be split into one or more component parts.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects to be illustrative and not restrictive.

This application is based upon and claims the benefit of priority from Singaporean Patent Application No. 10202301201Q, filed on Apr. 28, 2023, the disclosure of which is incorporated herein in its entirety by reference.

For example, the whole or part of the exemplary example embodiments disclosed above can be described as, but not limited to, the following supplementary notes.

### (Supplementary Note 1)

A method for identifying a task performed by a person from a series of video frames, the method comprising:
determining, by a processor, whether each of a first sequence of movement points and a second sequence of movement points comprises a first movement point at a first ordinal number and a second movement point at a second ordinal number within the each of the first sequence of movement points and the second sequence of movement points, wherein the first sequence of movement points and the second sequence of movement points comprise a first plurality of movement points and a second plurality of movement points of one or more body parts of the person ordered according to respective time points at which the first plurality of movement points and the second plurality of movement points are detected from a first series of video frames and a second series of video frames corresponding to a detection area, respectively; and
in response to a result of the determination, identifying, by the processor, a start and an end of a sequence of movement points to perform the task by the person from the first sequence of movement points and/or the second sequence of movement points based on the first movement point and the second movement point.

### (Supplementary Note 2)

The method according to Supplementary note 1, wherein the first sequence of movement points comprises the first movement point at a third ordinal number which is an ordinal number count away from the first ordinal number within the first sequence of movement points, the method further comprising:
increasing the third ordinal number of the first movement point and ordinal numbers of subsequent movement points within the first sequence of movement points by the ordinal number count such that the first movement point is at the first ordinal number of the first sequence of movement points, wherein the determination of the each of the first sequence of movement points and the second sequence of movement points is carried out after the increment.

### (Supplementary Note 3)

The method according to Supplementary note 2, wherein the increment of the third ordinal number of the first movement point and ordinal numbers of subsequent movement points comprises: increasing a number of the plurality of movement points of the first sequence of movement points by the ordinal number count.

### (Supplementary Note 4)

The method according to any one of Supplementary notes 1 to 3, wherein the first sequence of movement points comprises a third movement point at the first ordinal number, and the determination of the each of the first sequence of movement points and the second sequence of movement points comprises:
determining whether the third movement point is within a threshold distance from the first movement point; and
determining whether the each of the first sequence of movement points and the second sequence of movement points comprises the first movement point or the third movement point at the first ordinal number and the second movement point at the second ordinal number within the each of the first sequence of movement points and the second sequence of movement points.

### (Supplementary Note 5)

The method according to any one of Supplementary notes 1 to 4, further comprising:
detecting the one or more body parts of the person at a portion of the detection area in each video frame of each of the first and second series of video frames; and
assigning a movement point corresponding to the portion of the detection area in the each video frame of the each of the first and second series of video frames.

### (Supplementary Note 6)

The method according to Supplementary note 5, further comprising:
determining if a first portion of the detection area in a first video frame of one of the first and second of video frames and a second portion of the detection area in a second video frame of the one of the first and second series of video frames are both within one of a plurality of smaller detection areas of the detection area, each of the plurality of smaller detection areas occupying different x- and y-coordinates within the detection area; and
assigning a single movement point corresponding to the first and second portions of the detection area.

### (Supplementary Note 7)

The method according to Supplementary note 5 or 6, wherein the detection of the one or more body parts of the person at the portion of the detection area in the each video frame of the each of the first and second series of video frames comprises:
detecting a switch in a movement direction of the one or more body parts of the person at the portion of the detection area in the each video frame of the each of the first and second series of video frames.

### (Supplementary Note 8)

The method according to Supplementary note 7, further comprising:
determining if an angle between a previous movement direction of the one or more body parts of the person detected at a previous time point prior to the time point at which one or more body parts of the person is detected at the portion of the detection area and a subsequent movement direction of the one or more body parts of the person detected at a subsequent time point after the time point at which one or more body parts of the person is detected at the portion of the detection area is larger than a threshold angle, wherein the detection of the switch in the movement direction of the one or more body parts of the person is based on a result of the determination of the angle.

### (Supplementary Note 9)

The method according to any one of Supplementary notes 5 to 8, further comprising:
determining if the one or more body parts of the person is stationary or with a movement within a time period at the portion of the detection area in the each video frame of the each of the first and second series of video frames, wherein the assignment of the movement point corresponding to the portion of the detection area is based on a result of the determination of the one or more body parts of the person.

### (Supplementary Note 10)

The method according to any one of Supplementary notes 1 to 9, wherein one of the first movement point and the second movement point is one of two movement points identified as a start and an end of another sequence of movement points to perform another task by the person from a third sequence of movement points comprising a third plurality of movement points of the one or more body parts of the person detected from the first series of video frames and a fourth sequence of movement points comprising a fourth plurality of movement points of the one or more body parts of the person detected from the second series of video frames, the task and the another task being two of a series of task ordered according to respective time points at which movement points of the sequence of movement points and the another movement points are detected.

### (Supplementary Note 11)

The method according to any one of Supplementary notes 1 to 10, wherein the determination of the each of the first sequence of movement points and the second sequence of movement points comprises:
determining whether the each of the first sequence of movement points and the second sequence of movement points comprises a first movement pattern and a second movement pattern within the each of the first sequence of movement points and the second sequence of movement points, and
wherein the identification of the start and the end of the sequence of movement points to perform the task by the person in response to the result of the determination is based on the first movement pattern and the second movement pattern.

### (Supplementary Note 12)

The method according to any one of Supplementary notes 1 to 11, wherein the first series of video frames and the second series of video frames are from two different videos.

### (Supplementary Note 13)

The method according to any one of Supplementary notes 1 to 12, further comprising:
extracting first data and second data relating to the one or more body parts of the person performing the sequence of movement points from the first sequence of movement points and the second sequence of movement points, respectively; determining if an amount of the first data not present in the second data is larger than a threshold amount; and
displaying at least a part of the first data not present in the second data in a different colour different from that of the other part of the first data and the second data over the detection area.

### (Supplementary Note 14)

An apparatus for identifying a task performed by a person from a series of video frames, the apparatus comprising:
at least one processor; and
at least one memory including computer program code,
wherein the at least one memory and the computer program code are configured to, with the at least one processor, cause the apparatus at least to:
determine whether each of a first sequence of movement points and a second sequence of movement points comprises a first movement point at a first ordinal number and a second movement point at a second ordinal number within the each of the first sequence of movement points and the second sequence of movement points, wherein the first sequence of movement points and the second sequence of movement points comprise a first plurality of movement points and a second plurality of movement points of one or more body parts of the person ordered according to respective time points at which the first plurality of movement points and the second plurality of movement points are detected from a first series of video frames and a second series of video frames corresponding to a detection area, respectively; and
identify, in response to a result of the determination, a start and an end of a sequence of movement points to perform the task by the person from the first sequence of movement points and/or the second sequence of movement points based on the first movement point and the second movement point.

### (Supplementary Note 15)

The apparatus according to Supplementary note 14, wherein the first sequence of movement points comprises the first movement point at a third ordinal number which is an ordinal number count away from the first ordinal number within the first sequence of movement points, and wherein the at least one memory and the computer program code are configured to, with at least one processor, cause the apparatus at least to:
increase the third ordinal number of the first movement point and ordinal numbers of subsequent movement points within the first sequence of movement points by the ordinal number count such that the first movement point is at the first ordinal number of the first sequence of movement points; and
determine whether the each of the first sequence of movement points and the second sequence of movement points comprises the first movement at the first ordinal number and the second movement point at the second ordinal number within the each of the first sequence of movement points and the second sequence of movement points after the increment.

### (Supplementary Note 16)

The apparatus according to Supplementary note 15, wherein the at least one memory and the computer program code are configured to, with at least one processor, cause the apparatus at least to:
increase a number of the plurality of movement points of the first sequence of movement points by the ordinal number count with the increment of the third ordinal number of the first movement point and ordinal numbers of subsequent movement points.

### (Supplementary Note 17)

The apparatus according to any one of Supplementary notes 14 to 16, wherein the first sequence of movement points comprises a third movement point at the first ordinal number, wherein the at least one memory and the computer program code are configured to, with at least one processor, cause the apparatus at least to:
determine whether the third movement point is within a threshold distance from the first movement point; and
determine whether the each of the first sequence of movement points and the second sequence of movement points comprises the first movement point or the third movement point at the first ordinal number and the second movement point at the second ordinal number within the each of the first sequence of movement points and the second sequence of movement points.

### (Supplementary Note 18)

The apparatus according to any one of Supplementary notes 14 to 17, wherein the at least one memory and the computer program code are configured to, with at least one processor, cause the apparatus at least to:
detect the one or more body parts of the person at a portion of the detection area in each video frame of each of the first and second series of video frames; and
assign a movement point corresponding to the portion of the detection area in the each video frame of the each of the first and second series of video frames.

### (Supplementary Note 19)

The apparatus according to Supplementary note 18, wherein the at least one memory and the computer program code are configured to, with at least one processor, cause the apparatus at least to:
determine if a first portion of the detection area in a first video frame of one of the first and second of video frames and a second portion of the detection area in a second video frame of the one of the first and second series of video frames are both within one of a plurality of smaller detection areas of the detection area, each of the plurality of smaller detection areas occupying different x- and y-coordinates within the detection area; and
assign a single movement point corresponding to the first and second portions of the detection area.

### (Supplementary Note 20)

The apparatus according to Supplementary note 18 or 19, wherein the at least one memory and the computer program code are configured to, with at least one processor, cause the apparatus at least to:
detect a switch in a movement direction of the one or more body parts of the person at the portion of the detection area in the each video frame of the each of the first and second series of video frames to detect the one or more body parts of the person at the portion of the detection area in the each video frame of the each of the first and second series of video frames.

### (Supplementary Note 21)

The apparatus according to Supplementary note 20, wherein the at least one memory and the computer program code are configured to, with at least one processor, cause the apparatus at least to:
determine if an angle between a previous movement direction of the one or more body parts of the person detected at a previous time point prior to the time point at which one or more body parts of the person is detected at the portion of the detection area and a subsequent movement direction of the one or more body parts of the person detected at a subsequent time point after the time point at which one or more body parts of the person is detected at the portion of the detection area is larger than a threshold angle; and
detect the switch in the movement direction of the one or more body parts of the person based on a result of the determination of the angle.

### (Supplementary Note 22)

The apparatus according to any one of Supplementary notes 18 to 21, wherein the at least one memory and the computer program code are configured to, with at least one processor, cause the apparatus at least to:
determine if the one or more body parts of the person is stationary or with a movement within a time period at the portion of the detection area in the each video frame of the each of the first and second series of video frames; and
assign the movement point corresponding to the portion of the detection area based on a result of the determination of the one or more body parts of the person.

### (Supplementary Note 23)

The apparatus according to any one of Supplementary notes 14 to 22, wherein one of the first movement point and the second movement point is one of two movement points identified as a start and an end of another sequence of movement points to perform another task by the person from a third sequence of movement points comprising a third plurality of movement points of the one or more body parts of the person detected from the first series of video frames and a fourth sequence of movement points comprising a fourth plurality of movement points of the one or more body parts of the person detected from the second series of video frames, the task and the another task being two of a series of task ordered according to respective time points at which movement points of the sequence of movement points and the another movement points are detected.

### (Supplementary Note 24)

The apparatus according to any one of Supplementary notes 14 to 23, wherein the at least one memory and the computer program code are configured to, with at least one processor, cause the apparatus at least to:
determine whether the each of the first sequence of movement points and the second sequence of movement points comprises a first movement pattern and a second movement pattern within the each of the first sequence of movement points and the second sequence of movement points; and
identify the start and the end of the sequence of movement points to perform the task by the person in response to the result of the determination is based on the first movement pattern and the second movement pattern.

### (Supplementary Note 25)

The apparatus according to any one of Supplementary notes 14 to 24, wherein the at least one memory and the computer program code are configured to, with at least one processor, cause the apparatus at least to:
obtain the first series of video frames and the second series of video frames from two different videos.

### (Supplementary Note 26)

The apparatus according to any one of Supplementary notes 14 to 25, wherein the at least one memory and the computer program code configured to, with at least one processor, cause the apparatus at least to:
extract first data and second data relating to the one or more body parts of the person performing the sequence of movement points from the first sequence of movement points and the second sequence of movement points, respectively; determine if an amount of the first data not present in the second data is larger than a threshold amount; and
display at least a part of the first data constituting the amount of the first data not present in the second data in a colour different from that of the other part of the first data and the second data over the detection area.

### (Supplementary Note 27)

A system for identifying a task performed by a person from a series of video frames comprising the apparatus according to any one of Supplementary notes 14 to 26 and at least one video capturing apparatus configured to generate the first series of video frames and the second series of video frames.

### REFERENCE SIGNS LIST

400 SYSTEM
402 VIDEO CAPTURING DEVICE
404 APPARATUS
406 PROCESSOR
408 MEMORY
410 DATABASE
502 SETUP PHASE
504 OPERATION PHASE
506 SAMPLE VIDEO
508 CAMERA
1800 COMPUTING DEVICE
1802 DISPLAY INTERFACE
1804 PROCESSOR
1806 COMMUNICATION INFRASTRUCTURE
1808 MAIN MEMORY
1810 SECONDARY MEMORY
1812 STORAGE DRIVE
1814 REMOVABLE STORAGE DRIVE
1818 REMOVABLE STORAGE MEDIUM
1820 INTERFACE
1822 REMOVABLE STORAGE UNIT
1824 COMMUNICATION INTERFACE
1826 COMMUNICATION PATH
1830 DISPLAY
1832 AUDIO INTERFACE
1834 SPEAKER

What is claimed is:

1. A method for identifying a task performed by a person from a series of video frames, the method comprising:
determining, by a processor, whether each of a first sequence of movement points and a second sequence of movement points comprises a first movement point at a first ordinal number and a second movement point at a second ordinal number within the each of the first sequence of movement points and the second sequence of movement points, wherein the first sequence of movement points and the second sequence of movement points comprise a first plurality of movement points and a second plurality of movement points of one or more body parts of the person ordered according to respective time points at which the first plurality of movement points and the second plurality of movement points are detected from a first series of video frames and a second series of video frames corresponding to a detection area, respectively; and
in response to a result of the determination, identifying, by the processor, a start and an end of a sequence of movement points to perform the task by the person from the first sequence of movement points and/or the second sequence of movement points based on the first movement point and the second movement point.

2. The method according to claim 1, wherein the first sequence of movement points comprises the first movement point at a third ordinal number which is an ordinal number count away from the first ordinal number within the first sequence of movement points, the method further comprising:
increasing the third ordinal number of the first movement point and ordinal numbers of subsequent movement points within the first sequence of movement points by the ordinal number count such that the first movement point is at the first ordinal number of the first sequence of movement points, wherein the determination of the each of the first sequence of movement points and the second sequence of movement points is carried out after the increment.

3. The method according to claim 2, wherein the increment of the third ordinal number of the first movement point and ordinal numbers of subsequent movement points comprises: increasing a number of the plurality of movement points of the first sequence of movement points by the ordinal number count.

4. The method according to claim 1, wherein the first sequence of movement points comprises a third movement point at the first ordinal number, and the determination of the each of the first sequence of movement points and the second sequence of movement points comprises:
determining whether the third movement point is within a threshold distance from the first movement point; and
determining whether the each of the first sequence of movement points and the second sequence of movement points comprises the first movement point or the third movement point at the first ordinal number and the second movement point at the second ordinal number within the each of the first sequence of movement points and the second sequence of movement points.

5. The method according to claim 1, further comprising:
detecting the one or more body parts of the person at a portion of the detection area in each video frame of each of the first and second series of video frames; and
assigning a movement point corresponding to the portion of the detection area in the each video frame of the each of the first and second series of video frames.

6. The method according to claim 5, further comprising:
determining if a first portion of the detection area in a first video frame of one of the first and second of video frames and a second portion of the detection area in a second video frame of the one of the first and second series of video frames are both within one of a plurality of smaller detection areas of the detection area, each of the plurality of smaller detection areas occupying different x- and y-coordinates within the detection area; and
assigning a single movement point corresponding to the first and second portions of the detection area.

7-13. (canceled)

14. An apparatus for identifying a task performed by a person from a series of video frames, the apparatus comprising:
at least one processor; and
at least one memory including computer program code, wherein the at least one memory and the computer program code are configured to, with the at least one processor, cause the apparatus at least to:
determine whether each of a first sequence of movement points and a second sequence of movement points comprises a first movement point at a first ordinal number and a second movement point at a second ordinal number within the each of the first sequence of movement points and the second sequence of movement points, wherein the first sequence of movement points and the second sequence of movement points comprise a first plurality of movement points and a second plurality of movement points of one or more body parts of the person ordered according to respective time points at which the first plurality of movement points and the second plurality of movement points are detected from a first series of video frames and a second series of video frames corresponding to a detection area, respectively; and
identify, in response to a result of the determination, a start and an end of a sequence of movement points to perform the task by the person from the first sequence of movement points and/or the second sequence of movement points based on the first movement point and the second movement point.

15. The apparatus according to claim 14, wherein the first sequence of movement points comprises the first movement point at a third ordinal number which is an ordinal number count away from the first ordinal number within the first sequence of movement points, and wherein the at least one memory and the computer program code are configured to, with at least one processor, cause the apparatus at least to:
increase the third ordinal number of the first movement point and ordinal numbers of subsequent movement points within the first sequence of movement points by the ordinal number count such that the first movement point is at the first ordinal number of the first sequence of movement points; and
determine whether the each of the first sequence of movement points and the second sequence of movement points comprises the first movement at the first ordinal number and the second movement point at the second ordinal number within the each of the first sequence of movement points and the second sequence of movement points after the increment.

16. The apparatus according to claim 15, wherein the at least one memory and the computer program code are configured to, with at least one processor, cause the apparatus at least to:
increase a number of the plurality of movement points of the first sequence of movement points by the ordinal number count with the increment of the third ordinal number of the first movement point and ordinal numbers of subsequent movement points.

17. The apparatus according to claim 14, wherein the first sequence of movement points comprises a third movement point at the first ordinal number, wherein the at least one memory and the computer program code are configured to, with at least one processor, cause the apparatus at least to:
determine whether the third movement point is within a threshold distance from the first movement point; and
determine whether the each of the first sequence of movement points and the second sequence of movement points comprises the first movement point or the third movement point at the first ordinal number and the second movement point at the second ordinal number within the each of the first sequence of movement points and the second sequence of movement points.

18. The apparatus according to claim 14, wherein the at least one memory and the computer program code are configured to, with at least one processor, cause the apparatus at least to:
detect the one or more body parts of the person at a portion of the detection area in each video frame of each of the first and second series of video frames; and
assign a movement point corresponding to the portion of the detection area in the each video frame of the each of the first and second series of video frames.

19. The apparatus according to claim 18, wherein the at least one memory and the computer program code are configured to, with at least one processor, cause the apparatus at least to:
determine if a first portion of the detection area in a first video frame of one of the first and second of video frames and a second portion of the detection area in a second video frame of the one of the first and second series of video frames are both within one of a plurality of smaller detection areas of the detection area, each of the plurality of smaller detection areas occupying different x- and y-coordinates within the detection area; and
assign a single movement point corresponding to the first and second portions of the detection area.

20. The apparatus according to claim 18, wherein the at least one memory and the computer program code are configured to, with at least one processor, cause the apparatus at least to:
detect a switch in a movement direction of the one or more body parts of the person at the portion of the detection area in the each video frame of the each of the first and second series of video frames to detect the one or more body parts of the person at the portion of the detection area in the each video frame of the each of the first and second series of video frames.

21. The apparatus according to claim 20, wherein the at least one memory and the computer program code are configured to, with at least one processor, cause the apparatus at least to:
determine if an angle between a previous movement direction of the one or more body parts of the person detected at a previous time point prior to the time point at which one or more body parts of the person is detected at the portion of the detection area and a subsequent movement direction of the one or more body parts of the person detected at a subsequent time point after the time point at which one or more body parts of the person is detected at the portion of the detection area is larger than a threshold angle; and
detect the switch in the movement direction of the one or more body parts of the person based on a result of the determination of the angle.

22. The apparatus according to claim 18, wherein the at least one memory and the computer program code are configured to, with at least one processor, cause the apparatus at least to:
determine if the one or more body parts of the person is stationary or with a movement within a time period at the portion of the detection area in the each video frame of the each of the first and second series of video frames; and
assign the movement point corresponding to the portion of the detection area based on a result of the determination of the one or more body parts of the person.

23. The apparatus according to claim 14, wherein one of the first movement point and the second movement point is one of two movement points identified as a start and an end of another sequence of movement points to perform another task by the person from a third sequence of movement points comprising a third plurality of movement points of the one or more body parts of the person detected from the first series of video frames and a fourth sequence of movement points comprising a fourth plurality of movement points of the one or more body parts of the person detected from the second series of video frames, the task and the another task being two of a series of task ordered according to respective time points at which movement points of the sequence of movement points and the another movement points are detected.

24. The apparatus according to claim 14, wherein the at least one memory and the computer program code are configured to, with at least one processor, cause the apparatus at least to:
determine whether the each of the first sequence of movement points and the second sequence of movement points comprises a first movement pattern and a second movement pattern within the each of the first sequence of movement points and the second sequence of movement points; and
identify the start and the end of the sequence of movement points to perform the task by the person in response to the result of the determination is based on the first movement pattern and the second movement pattern.

25. The apparatus according to claim 14, wherein the at least one memory and the computer program code are configured to, with at least one processor, cause the apparatus at least to:
obtain the first series of video frames and the second series of video frames from two different videos.

26. The apparatus according to claim 14, wherein the at least one memory and the computer program code configured to, with at least one processor, cause the apparatus at least to:
extract first data and second data relating to the one or more body parts of the person performing the sequence of movement points from the first sequence of movement points and the second sequence of movement points, respectively;
determine if an amount of the first data not present in the second data is larger than a threshold amount; and
display at least a part of the first data constituting the amount of the first data not present in the second data in a colour different from that of the other part of the first data and the second data over the detection area.

27. (canceled)

28. A non-transitory computer-readable medium storing a program that causes a processor to execute a process for identifying a task performed by a person from a series of video frames, the process comprising:
determining whether each of a first sequence of movement points and a second sequence of movement points comprises a first movement point at a first ordinal number and a second movement point at a second ordinal number within the each of the first sequence of movement points and the second sequence of movement points, wherein the first sequence of movement points and the second sequence of movement points comprise a first plurality of movement points and a second plurality of movement points of one or more body parts of the person ordered according to respective time points at which the first plurality of movement points and the second plurality of movement points are detected from a first series of video frames and a second series of video frames corresponding to a detection area, respectively; and
in response to a result of the determination, identifying a start and an end of a sequence of movement points to perform the task by the person from the first sequence of movement points and/or the second sequence of movement points based on the first movement point and the second movement point.
